(19) United States
(12) Patent Application Publication
(10) Pub. No.: US 2023/0186270 A1
(43) Pub. Date: Jun. 15, 2023

(54) Methods to Prevent Accidental Triggers for Off-Platter Detection Systems

(71) Applicant: ZEBRA TECHNOLOGIES CORPORATION, Lincolnshire, IL (US)

(72) Inventors: Edward Barkan, Miller Place, NY (US); Christopher J. Fjellstad, Smithtown, NY (US); Darran Michael Handshaw, Sound Beach, NY (US); Yuri Astvatsaturov, Lake Forest, IL (US)

(21) Appl. No.: 17/546,862

(22) Filed: Dec. 9, 2021

(51) Int. Cl. G06Q 20/20

(52) U.S. Cl. CPC G06Q 20/208

(57) ABSTRACT

Techniques for preventing accidental triggers for off-platter detection systems are disclosed herein. An example system includes a weigh platter having a first surface; a scale configured to measure a weight of an object placed on the first surface; an off-platter detection assembly configured to detect an off-platter condition based on a portion of the object resting on a second surface off the weigh platter and/or some portion of the object extending beyond a perimeter of the weigh platter; a processor in communication with the scale and the off-platter detection assembly; and a non-transitory machine-readable storage medium storing instructions that, when executed by the processor, cause the system to generate an alert responsive to at least: (i) the off-platter detection assembly detecting the off-platter condition and (ii) a measurement by the scale of a stable weight greater than a threshold weight, for a time period greater than a threshold time period.

### BACKGROUND

One of the functions of a checkout workstation with a weighing platter is to weigh produce or other products that are priced by weight in order to assist in determining the price of the produce or product. However, produce and products are varied in shape and size and there can be issues where part of the produce or product sits off of the weigh platter, resulting in incorrect weight measurement and, therefore, incorrect pricing. Consequently, alerts may be generated when produce or products being weighed on a weighing platter of a checkout workstation extend off of the weigh platter during the weighing process in order to reduce or eliminate instances of incorrect weight measurement and allow the user to identify and correct the problem before a price for the produce or products is calculated so that weight-based pricing will be accurate. However, in some instances, these generated alerts can become excessive and frustrating for users, e.g., if audible and/or visible alerts are generated for “false positives,” when the object momentarily moves off the weight platter before settling, or when the weight of the object is not relevant. Therefore, there is a need to prevent triggering of off-platter detection system alerts when these alerts are not necessary.

### SUMMARY

In an embodiment, the present invention is a system for use with a point of sale (POS) terminal that is operable to execute a transaction associated with a purchase of an object, the system comprising: a weigh platter having a first surface extending in a first transverse plane; a scale configured to measure a weight of the object when placed on the first surface; an off-platter detection assembly configured to detect an off-platter condition based on at least one of (i) a portion of the object resting on a second surface off the weigh platter or (ii) at least some portion of the object extending beyond a perimeter of the weigh platter; a processor in communication with the scale and the off-platter detection assembly; and a non-transitory machine-readable storage medium storing instructions that, when executed by the processor, cause the system to generate an alert responsive to at least: (i) the off-platter detection assembly detecting the off-platter condition and (ii) a measurement by the scale of a stable weight greater than a threshold weight, for a time period greater than a threshold time period.

In another embodiment, the present invention is a system for use with a point of sale (POS) terminal that is operable to execute a transaction associated with a purchase of an object, the system comprising: a weigh platter having a first surface extending in a first transverse plane; a scale configured to measure a weight of the object when placed on the first surface; an off-platter detection assembly configured to detect an off-platter condition based on at least one of (i) a portion of the object resting on a second surface off the weigh platter or (ii) at least some portion of the object extending beyond a perimeter of the weigh platter; an imaging assembly configured to capture image data associated with the object when placed on the first surface; a processor in communication with the scale and the off-platter detection assembly; and a non-transitory machine-readable storage medium storing instructions that, when executed by the processor, cause the system to: analyze the image data associated with the object captured by the imaging assembly to identify at least one parameter related to the object; and generate an alert responsive to at least: (i) the off-platter detection assembly detecting the off-platter condition and (ii) a secondary condition, based on identifying the at least one parameter related to the object, being met.

In a variation on this embodiment, analyzing the image data associated with the object to identify at least one parameter related to the object includes analyzing the image data associated with the object to identify a payload of a barcode associated with the object.

As another example, in a variation on this embodiment, analyzing the image data associated with the object to identify at least one parameter related to the object includes analyzing the image data associated with the object using object recognition techniques to identify the object.

As still another example, in a variation on this embodiment, the secondary condition is based on identifying that the object is a produce object.

As yet another example, in a variation on this embodiment, the secondary condition is based on identifying that the object is associated with a price value above a threshold price value.

Additionally, in an example, in a variation of this embodiment, the secondary condition is based on identifying that the object is priced based on weight.

Moreover, in an example, in a variation of this embodiment, the alert is further responsive to: a measurement by the scale of a stable weight for a time period greater than a threshold time period.

Furthermore, in an example, in a variation of this embodiment, the alert is further responsive to: a measurement by the scale of a weight greater than a threshold weight.

In another example, in a variation of this embodiment, the alert is further responsive to: identifying an indication that the object has been placed on the first surface for a time period greater than a threshold time period.

In yet another example, in a variation of this embodiment, identifying the indication that the object has been placed on the first surface for the time period greater than the threshold time period includes analyzing the image data captured by the imaging assembly to determine that pixels of the image data having a brightness greater than a threshold brightness threshold have not moved for the time period.

In yet another embodiment, the present invention is a system for use with a point of sale (POS) terminal that is operable to execute a transaction associated with a purchase of an object, the system comprising: a weigh platter having a first surface extending in a first transverse plane; a scale configured to measure a weight of the object when placed on the first surface; an off-platter detection assembly configured to detect an off-platter condition based on at least one of (i) a portion of the object resting on a second surface off the weigh platter or (ii) at least some portion of the object extending beyond a perimeter of the weigh platter; a user interface configured to capture user input associated with the object; a processor in communication with the scale and the off-platter detection assembly; and a non-transitory machine-readable storage medium storing instructions that, when executed by the processor, cause the system to analyze the user input associated with the object captured by to identify at least one parameter related to the object; and generate an alert responsive to at least: (i) the off-platter detection assembly detecting the off-platter condition and (ii) a secondary condition, based on identifying the at least one parameter related to the object, being met.

In a variation on this embodiment, the secondary condition is based on identifying that the object is a produce object.

As another example, in a variation on this embodiment, the secondary condition is based on identifying that the object is associated with a price value above a threshold price value.

As still another example, in a variation on this embodiment, the secondary condition is based on identifying that the object is priced based on weight.

As yet another example, in a variation on this embodiment, the alert is further responsive to: a measurement by the scale of a stable weight for a time period greater than a threshold time period.

Additionally, in an example, in a variation of this embodiment, the alert is further responsive to: a measurement by the scale of a weight greater than a threshold weight.

In still yet another embodiment, the present invention is a system for use with a point of sale (POS) terminal that is operable to execute a transaction associated with a purchase of an object, the system comprising: a weigh platter having a first surface extending in a first transverse plane; a scale configured to measure a weight of the object when placed on the first surface; an off-platter detection assembly configured to detect an off-platter condition based on at least one of (i) a portion of the object resting on a second surface off the weigh platter or (ii) at least some portion of the object extending beyond a perimeter of the weigh platter; a product identification module configured to capture data associated with the object; a processor in communication with the scale and the off-platter detection assembly; and a non-transitory machine-readable storage medium storing instructions that, when executed by the processor, cause the system to: analyze the data captured by the product identification module to identify at least one parameter related to the object; and generate an alert responsive to at least: (i) the off-platter detection assembly detecting the off-platter condition and (ii) the at least one parameter associated with the object.

In a variation on this embodiment, the secondary condition is based on identifying that the object is a produce object.

As another example, in a variation on this embodiment, the secondary condition is based on identifying that the object is associated with a price value above a threshold price value.

As still another example, in a variation on this embodiment, the secondary condition is based on identifying that the object is priced based on weight.

As yet another example, in a variation on this embodiment, the alert is further responsive to: a measurement by the scale of a stable weight for a time period greater than a threshold time period.

Additionally, as another example, in a variation on this embodiment, the alert is further responsive to: a measurement by the scale of a weight greater than a threshold weight.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of an example system including a logic circuit for implementing the example methods and/or operations described herein, including methods for preventing accidental triggers for off-platter detection systems.

FIG. 2 illustrates a front perspective view of a first example checkout workstation having an off-platter detection assembly with a first example off-platter indication system.

FIG. 3 illustrates a top view of the checkout workstation of FIG. 2 with an object extending across a first lateral edge of the weigh platter.

FIG. 4 illustrates a front perspective view of a second example checkout workstation having an off-platter detection assembly with a second example off-platter indication system.

FIG. 5 illustrates a front view of the checkout workstation of FIG. 4 with an object extending across a first lateral edge of the weigh platter.

FIG. 6 illustrates a side view of the checkout workstation of FIG. 2 with one example off-platter detection assembly.

FIG. 7 illustrates a top view of the checkout workstation of FIG. 6 with an object extending across a first lateral edge of the weigh platter.

FIG. 8 illustrates a side view of the checkout workstation of FIG. 4 with another example off-platter detection assembly.

FIG. 9 illustrates a front view of the checkout workstation of FIG. 8 with an object extending across a first lateral edge of the weigh platter.

FIG. 10 illustrates a side view of a third example checkout workstation having an off-platter detection assembly with a third example off-platter indication system.

FIG. 11 illustrates a front view of the checkout workstation of FIG. 10 with an object extending across a first lateral edge of the weigh platter.

FIG. 12 illustrates a block diagram of an example process as may be implemented by the system of FIG. 1, for implementing example methods and/or operations described herein, including methods for preventing accidental triggers for off-platter detection systems based on input from a weighing scale.

FIG. 13 illustrates a block diagram of an example process as may be implemented by the system of FIG. 1, for implementing example methods and/or operations described herein, including methods for preventing accidental triggers for off-platter detection systems based on input from an imaging assembly.

FIG. 14 illustrates a block diagram of an example process as may be implemented by the system of FIG. 1, for implementing example methods and/or operations described herein, including methods for preventing accidental triggers for off-platter detection systems based on input from a user.

FIG. 15 illustrates a block diagram of an example process as may be implemented by the system of FIG. 1, for implementing example methods and/or operations described herein, including methods for preventing accidental triggers for off-platter detection systems based on input from a product identification system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure generally relates to checkout workstations having off-platter detection systems that can be used to detect instances of off-platter conditions, in which at least a portion of an object to be purchased is not resting on the weighing platter of the checkout workstation. In particular, the present disclosure generally relates to preventing audible or visible alerts from being generated for false positives or other accidental triggers of the off-platter detection system. That is, these audible or visible alerts are useful for the user when a sustained off-platter condition is detected for a product having a price based on weight, but are less useful when a momentary off-platter condition is detected, or when an off-platter condition is detected for a product that is not priced based on weight.

In one example, the present disclosure provides a system and method in which an off-platter alert is not generated unless a positive, stable weight is detected on the scale and dwells for a certain amount of time. Accordingly, in this example, the system cannot be accidentally triggered by jarring the platter while the off-platter detection system notices something along the platter's edge. Furthermore, in some examples, a user may set a weight threshold, and when a weight measured by the scale is below the weight threshold, no off-platter alerts will be generated. For instance, the threshold could be set so that a weight measured by the scale that is less than the lightest object sold by the retail store, or the lightest object that is priced by weight, will not trigger an off-platter alert.

In another example, off-platter alerts are generated when an object placed on scale is not priced by weight, or is priced below a price threshold. For instance, an object recognition or identification system, which may include a color camera, a barcode reader, an RFID reader, or a user interface where a user provides information about the object, etc., may be used to identify the object placed on the scale or otherwise identify parameters (e.g., including package markings, barcodes, Digimarc®, etc.) associated with the object indicating that the object is not priced by weight or is priced below a price threshold. For instance, if the object is not produce, or otherwise is not priced by weight, there may be no need for off-platter alerts, because whether the object is on or off the platter is not relevant in pricing the object. In some examples, even if the object is priced by weight, if the price of the object is below a certain price threshold, there may be no need for off-platter alerts for the object.

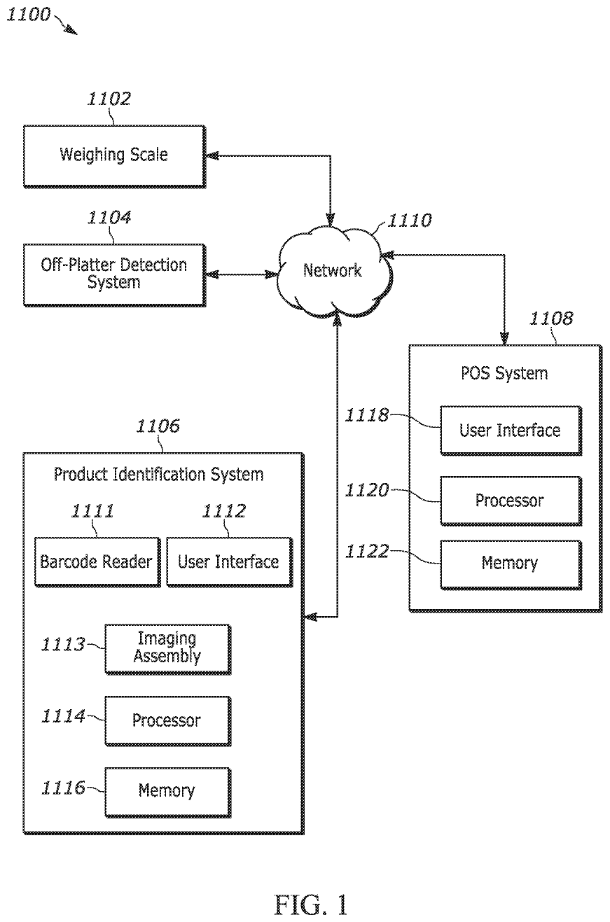

FIG. 1 illustrates a block diagram of an example checkout workstation system 1100 including a logic circuit for implementing the example methods and/or operations described herein, including methods for preventing accidental triggers for off-platter detection systems. The system 1100 may include a weighing scale 1102, an off-platter detection system 1104, a product identification system 1106, and a POS system 1108. The weighing scale 1102, off-platter detection system 1104, product identification system 1106, and POS system 1108 may each communicate with one another via a wired or wireless network 1110.

The weighing scale 1102 (e.g., such as the weigh platter assembly 100 discussed in greater detail below) may monitor the weight of objects placed on a weighing platter associated with the checkout workstation and may continuously or periodically log and send the monitored weights to the POS system 1108, e.g., via the network 1110.

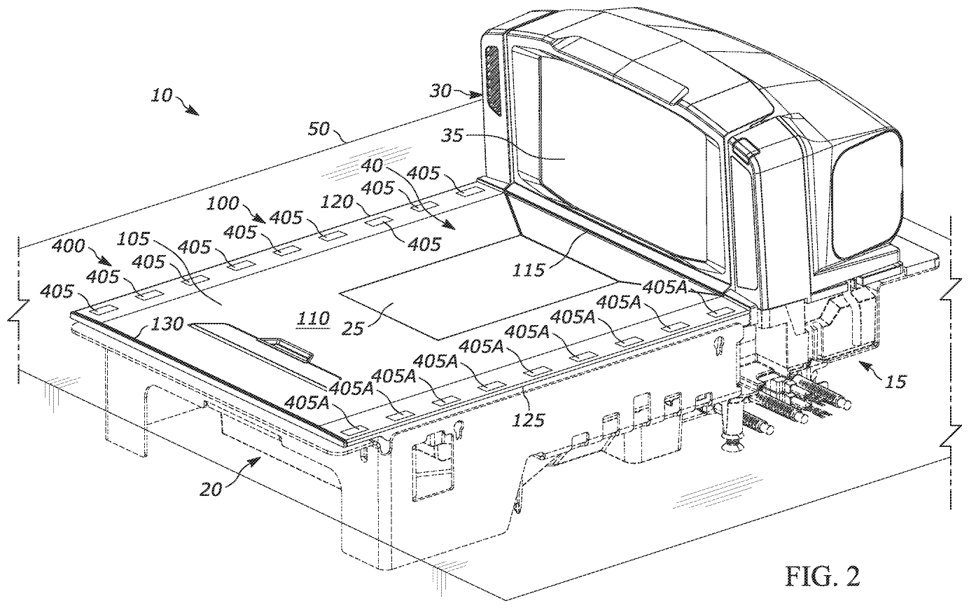

The off-platter detection system 1104 (also called an off-platter detection assembly, as discussed in greater detail with respect to FIGS. 2-11) is generally configured to detect instances of off-platter conditions in which at least a portion of an object to be purchased is not resting on the weighing platter. In some examples, the off-platter detection system 1104 may display audible or visible alerts or notifications to users when instances of off-platter conditions are detected and one or more secondary conditions (including, e.g., a secondary condition that the weight measured by the weighing scale 1102 has been stable for greater than a threshold period of time and/or has been above a threshold weight for greater than a threshold period of time; a secondary condition that the object is a particular type or category of object, such as produce; a secondary condition that the object is priced by weight; and/or a secondary condition that a price associated with the object is greater than a threshold price; etc.) are met as well, or may send indications of instances of off-platter conditions to the POS system 1108, e.g., via the network 1110, where alerts or notifications are to be presented to the user when instances of off-platter conditions are detected and the one or more secondary conditions are met. In some examples, the off-platter detection system 1104 may send indications of such instances to the product identification system 1106, e.g., via the network 1110.

The product identification system 1106 may be configured to identify objects to be purchased (and/or various parameters associated with objects to be purchased) that are placed on the weighing platter associated with the checkout workstation based on, e.g., reading barcodes associated with objects to be purchased by a barcode (or RFID) reader 1111, receiving user input identifying objects to be purchased via a user interface 1112, and/or capturing images of objects to be purchased by an imaging assembly 113. The product identification system 1106 may further include one or more processors 1114 and a memory 1116 (e.g., volatile memory, non-volatile memory) accessible by the one or more processors 1114 (e.g., via a memory controller). The one or more processors 1114 may interact with the memory 1116 to obtain, for example, computer-readable instructions stored in the memory 1116. The computer-readable instructions stored in the memory 1116, when executed by the one or more processors 1114, may cause the one or more processors 1114 to analyze the data captured by the product identification system 1106 to identify parameters associated with each object to be purchased, e.g., based on barcodes or RFID tags associated with the objects to be purchased, input from users (e.g., touchscreen or keyboard selections by users, audio input from users, etc.), and/or captured images of the objects, and send indications of the parameters associated with the objects to be purchased to the POS system 1108, e.g., via the network 1110. In some examples, analyzing the data associated with the object to identify at least one parameter related to the object may include analyzing the image data associated with the object to identify a payload of a barcode or RFID tag associated with the object, which may include an indication of an identification of the object, a price of associated with the object, and/or a category associated with the object (e.g., produce or not produce, priced by weight or not priced by weight, etc.), etc. Additionally, in some examples, analyzing the data associated with the object to identify at least one parameter related to the object may include analyzing any image data associated with the object using object recognition techniques to identify the object. Furthermore, in some examples, analyzing the data associated with the object to identify at least one parameter related to the object may include analyzing the data associated with the object (e.g., image data, user input data, etc.) to identify symbols or markings associated with the object, which may be indicative of an identification of the object, a price of associated with the object, and/or a category associated with the object (e.g., produce or not produce, priced by weight or not priced by weight, etc.), etc. In some examples, the data associated with the object may be analyzed to identify an indication of the identification of the object, which in turn may be used to determine one or more further parameters associated with the object, such as a price of associated with the object, and/or a category associated with the object (e.g., produce or not produce, priced by weight or not priced by weight, etc.) e.g., by accessing a database storing various parameters associated with object identifications.

Moreover, in some examples, the computer-readable instructions stored on the memory 1116 may include instructions for receiving indications of instances of off-platter conditions detected by the off-platter detection system 1104, and generating off-platter alerts based on instances in which off-platter conditions are detected by the off-platter detection system 1104 and the one or more secondary conditions are met as well.

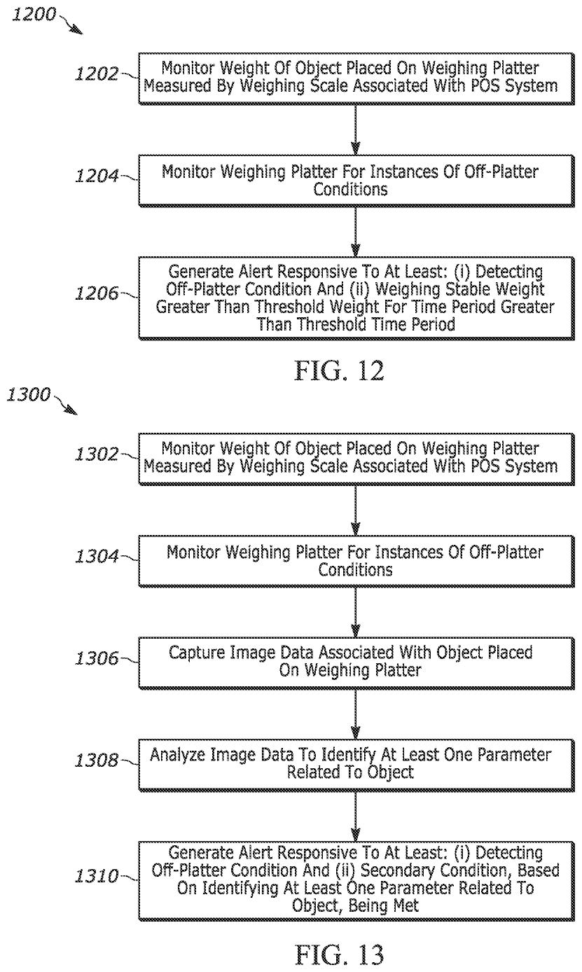

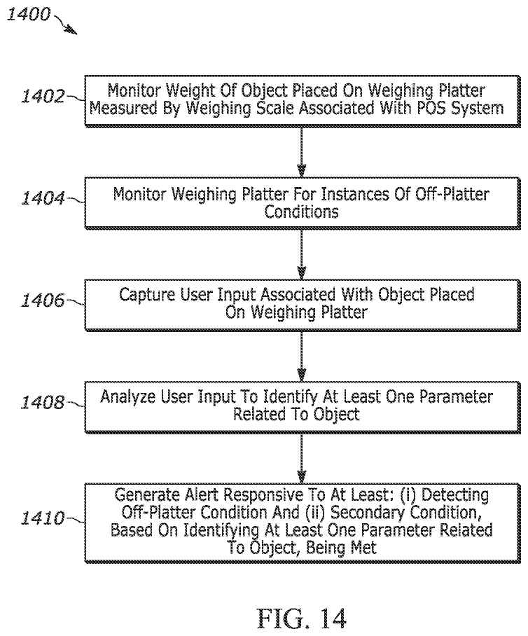

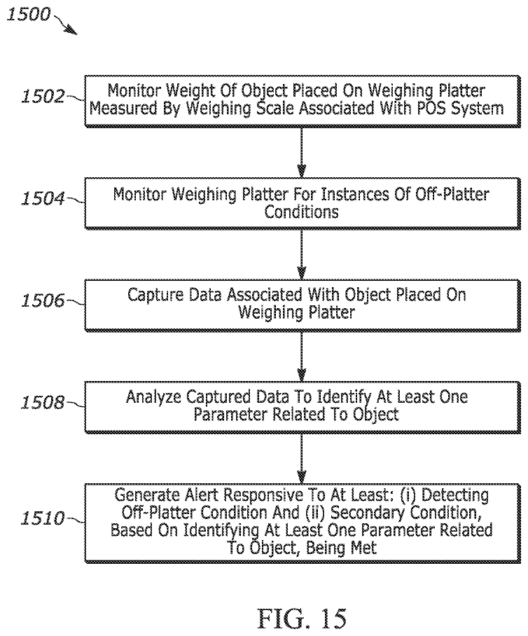

Additionally, the computer-readable instructions stored on the memory 1116 may include instructions for carrying out any of the steps of the method 1200, described in greater detail below with respect to FIG. 12, the steps of method 1300, described in greater detail below with respect to FIG. 13, the steps of method 1400, described in greater detail below with respect to FIG. 14, and/or the steps of method 1500, described in greater detail below with respect to FIG. 15.

The POS system 1108 may be configured to calculate prices of objects to be purchased by users, based on receiving an identification of the object as determined by the product identification system 1106 and based on the weight measured by the weighing scale 1102 at the time that the POS system 1108 receives the identification of the object. The POS system 1108 may include a user interface 1118 configured to receive input from users and provide information to users. The POS system 1108 may further include one or more processors 1120 and a memory 1122 (e.g., volatile memory, non-volatile memory) accessible by the one or more processors 1120 (e.g., via a memory controller). The one or more processors 1120 may interact with the memory 1122 to obtain, for example, computer-readable instructions stored in the memory 1122. The computer-readable instructions stored in the memory 1122, when executed by the one or more processors 1120, may cause the one or more processors 1120 to monitor the current weight measured by the weighing scale 1102, e.g., based on data sent from the weighing scale 1102 to the POS system 1108 via the network 1110. Furthermore, the computer-readable instructions stored on the memory 1122 may further include instructions for calculating a weight-based price for each object to be purchased based on the identification of the object and the weight measured by the weighing scale 1102 when the POS system 1108 receives the indication of the identification of the object. That is, the computer-readable instructions stored on the memory 1122 may cause the POS system 1108 to access a database listing prices per unit weight for the identified object, and may calculate the price of the object based on the price per weight and the weight at the time when the indication of the identification of object is received.

Additionally, in some examples, the computer-readable instructions stored on the memory 1122 may further include instructions for receiving indications of instances of off-platter conditions from the off-platter detection system 1104, e.g., via the network 1110, and displaying audible and/or visible notifications to the user in instances in which off-platter conditions are detected by the off-platter detection system 1104 and the one or more secondary conditions are met as well. For instance, the notifications may indicate possible ways that the user can correct the off-platter condition.

Furthermore, the computer-readable instructions stored on the memory 1122 may include instructions for carrying out any of the steps of the method 1200, described in greater detail below with respect to FIG. 12, the steps of method 1300, described in greater detail below with respect to FIG. 13, the steps of method 1400, described in greater detail below with respect to FIG. 14, and/or the steps of method 1500, described in greater detail below with respect to FIG. 15.

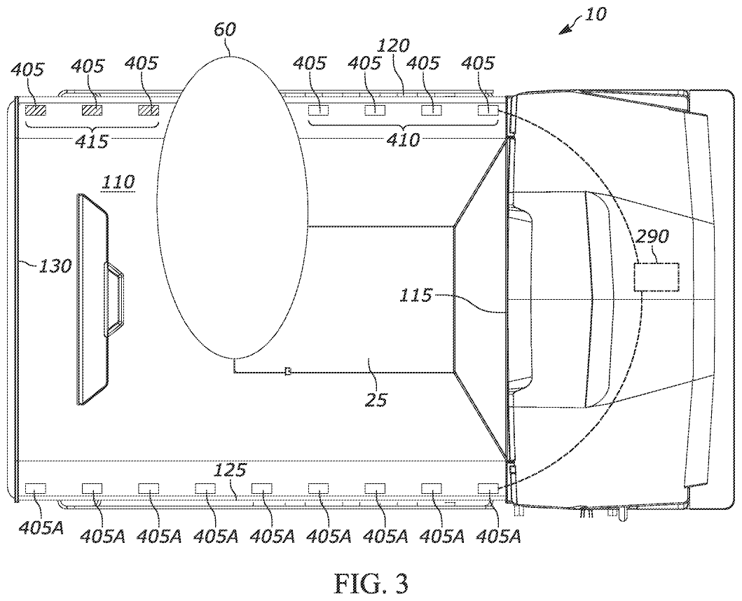

Referring to FIGS. 2-3, a first example checkout workstation 10, such as the Zebra® MP7000 bioptic barcode reader, is shown and can be configured to be supported by a checkout counter 50 at a POS of a retail store. Checkout workstation 10 has a housing 15 that includes a lower housing 20 that houses a weigh platter assembly 100 and an upper housing 30 that extends above lower housing 20. Upper housing 30 includes a generally vertical window 35 to allow a first set of optical components positioned within housing 15 to direct a first field-of-view through vertical window 35. In addition, if the checkout workstation 10 is a bioptic barcode reader, lower housing 20 will include a generally horizontal window 25, which in the example shown is positioned in a weigh platter 105 of weigh platter assembly 100 to allow a second set of optical components positioned within housing 15 to direct a second field of view through horizontal window 25. The first and second fields of view intersect to define a product scanning region 40 of checkout workstation 10 where a product can be scanned for sale at the POS.

Weigh platter assembly 100 generally includes a weigh platter 105 that is positioned within lower housing 20 and is configured to measure the weight of an object placed on weigh platter 105. Weigh platter 105 has upper surface 110 that faces product scanning region 40, a proximal edge 115, a first lateral edge 120, a second lateral edge 125, and a distal edge 130. In the example shown, proximal edge 115 is adjacent upper housing 30 and would be the edge furthest from a user of weigh platter assembly 100 and/or checkout workstation 10. First lateral edge 120 extends non-parallel to proximal edge 115. Second lateral edge 125 is opposite first lateral edge 120 and extends non-parallel to proximal edge 115. Distal edge 130 is opposite proximal edge 115, would be the edge closest to the user, and extends non-parallel to first and second lateral edges 120, 125. In the example shown, weigh platter is generally rectangular and first and second lateral edges 120, 125 are parallel and perpendicular to proximal edge 115 and distal edge 130 and distal edge is parallel to proximal edge 115.

The checkout workstation 10 in FIGS. 2-3 also includes an off-platter detection assembly with a first example off-platter indication system 200, which has a plurality of linearly aligned light sources 405 that each represent a location along first lateral edge 120 of weigh platter 105. In the example shown, light sources 405 can be any type of light source, such as light emitting diodes, and are positioned in upper surface 110 of weigh platter 105 and generally aligned along first lateral edge 120. In the example shown, light sources 405 are spread out along the entire length of weigh platter 105, however, light sources 405 can also be grouped closely together and positioned adjacent distal edge 130 of weigh platter 105 so that light sources 405 are easily viewable by a user and the chance that an object being weighed would obscure light sources 405 from the view of the user would be reduced. For simplicity, only light sources 405 along first lateral edge 120 are described herein, however, it will be understood that off-platter indication system 400 can also include a second plurality of linearly aligned light sources 405A along second lateral edge 125 to provide an indication of a potential off-platter event and the location of the potential off-platter event along second lateral edge 125. The off-platter detection assembly also has a controller 290 that is configured to determine if an object 60 (FIG. 3) extends over first lateral edge 120 of weigh platter 105 and, if so, determine the location of object 60 along first lateral edge 120, as described in more detail below. If controller 290 determines that object 60 extends over first lateral edge 120, the controller 290, which is operatively coupled to light sources 405, is configured to illuminate a first portion 410 of light sources 405 located between object 60 and proximal edge 115 of weigh platter 105 to represent the distance between proximal edge 115 and the location that object 60 crosses first lateral edge 120 and to de-illuminate a second portion 415 of light sources 405 located between object 60 and distal edge 130 of weigh platter 105 to represent the distance between the location that object 60 crosses first lateral edge 120 and distal edge 130. The de-illumination of second portion 415 of light sources 405 alerts the user that there is a potential off-platter event along first lateral edge 120 and the illumination of the first portion 410 of light sources 405 identifies to the user the location of the potential off-platter event. In addition, off-platter indication system can have a speaker or other audio device that can also provide audio notifications informing the user where the potential off-platter event is occurring (e.g., left side, right side, left side near upper housing, right side near end of platter, etc.).

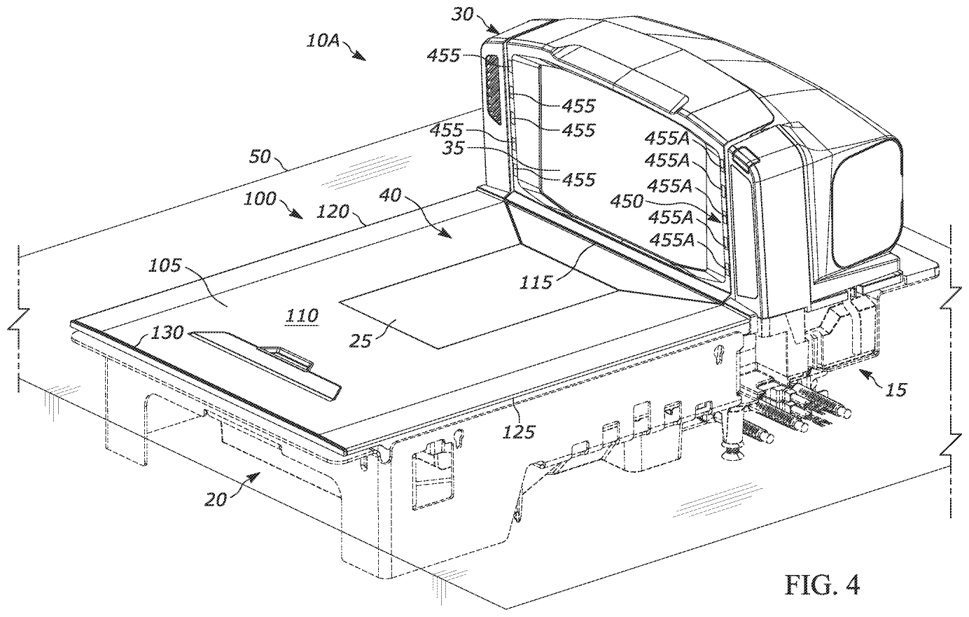

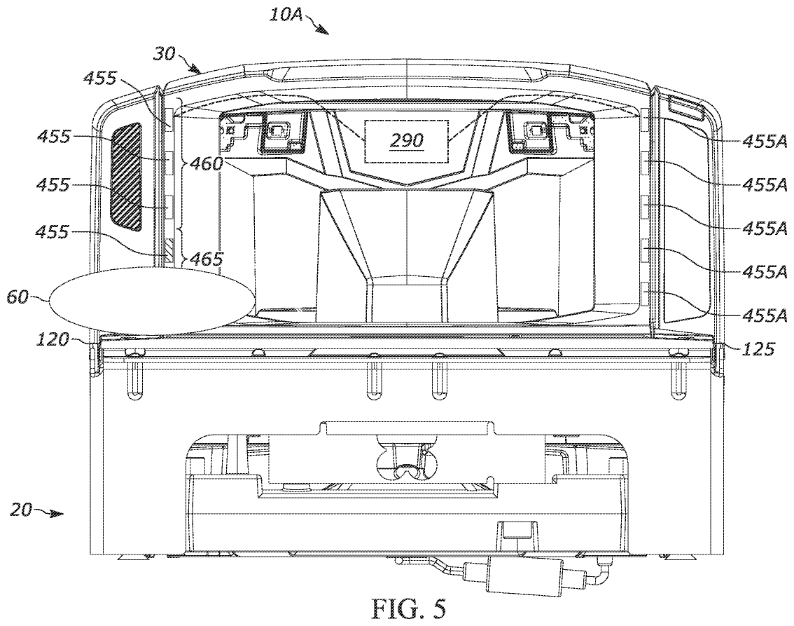

Referring to FIGS. 4-5, a second example checkout workstation 10A is illustrated that is the same as checkout workstation 10, but includes an off-platter detection assembly with a second example off-platter indication system 450, rather than off-platter indication system 400. Off-platter indication system 450 is similar to off-platter indication system 400 in that off-platter indication system 450 has a plurality of linearly aligned light sources 455 that each represent a location along first lateral edge 120 of weigh platter 105. In the example shown, light sources 405 can be any type of light source, such as light emitting diodes, and are positioned in upper housing 30 and are generally aligned with first lateral edge 120 of weigh platter 105 and directed towards distal edge 130 so they are visible by a user. In the example shown, light sources 455 are spread out along the entire height of upper housing 30, however, light sources 455 can also be grouped closely together and positioned adjacent the top of upper housing 30 so that light sources 455 are easily viewable by a user and the chance that a tall object being weighed would obscure light sources 455 from the view of the user would be reduced. Again, for simplicity, only light sources 455 aligned with first lateral edge 120 are described herein, however, it will be understood that off-platter indication system 450 can also include a second set of light sources 455A aligned with second lateral edge 125 to provide an indication of a potential off-platter event and the location of the potential off-platter event along second lateral edge 125. The off-platter detection assembly also has a controller 350 that is configured to determine if an object 60 (FIG. 5) extends over first lateral edge 120 of weigh platter 105 and, if so, determine the location of object 60 along first lateral edge 120, as described in more detail below. If controller 350 determines that object 60 extends over first lateral edge 120, controller 350, which is operatively coupled to light sources 455, is configured to illuminate a first portion 460 of light sources 455 to represent the distance between proximal edge 115 and the location that object 60 crosses first lateral edge 120 and to de-illuminate a second portion 465 of light sources 455 to represent the distance between the location that object 60 crosses first lateral edge 120 and distal edge 130. The de-illumination of second portion 465 of light sources 455 alerts the user that there is a potential off-platter event along first lateral edge 120 and the illumination of the first portion 460 of light sources 455 identifies to the user the location of the potential off-platter event.

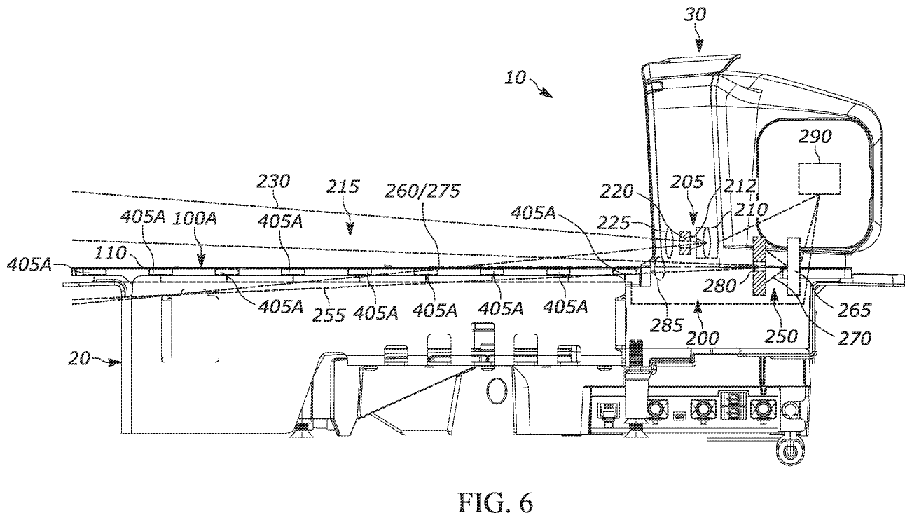

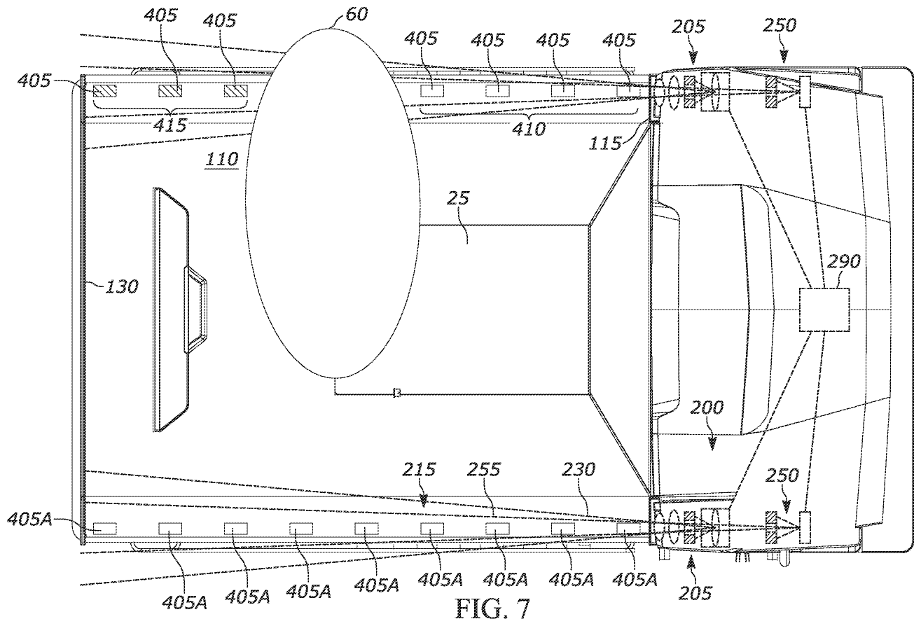

FIGS. 6-7 illustrate a checkout workstation 10 with an off-platter indication system 400 and one particular example of an off-platter detection assembly 200, which in the example shown is a LIDAR based system. The example off-platter detection assembly 200 generally includes a light emission assembly 205, a light detection assembly 250, and controller 290 operatively coupled to light emission assembly 205 and light detection assembly 250. For simplicity, only a single light emission assembly 205 and light detection assembly 250 along first lateral edge 120 are described herein, however, it will be understood that off-platter detection assembly 200 can also include a second light emission assembly and a second light detection assembly on an opposite side to detect objects that extend over second lateral edge 125, as shown in FIG. 7.

Light emission assembly 205 can be located within upper housing 30 of housing 15, has a light source 210, and is configured to emit pulses of light 215 away from proximal edge 115, towards distal edge 130, and along first lateral edge 120 of weigh platter 105. Light source 210 could be an LED that is focused into a narrow beam, similar to an aiming dot used in scanners, a focused laser beam, etc., and could be on the infrared wavelength, visible light wavelength, or any wavelength desired. Light source 210 can have a field-of-view 212 and light emission assembly 205 can also include an aperture 220, which could be formed in a wall or protrusion of housing 15 or could be formed through another wall or structure that is part of weigh platter assembly 100, positioned in front of light source 210 to constrain field-of-view 212 of light source 210 into a narrow field-of-view 230 along first lateral edge 120. A lens 225 can also be positioned in front of aperture 220 and configured to focus the one or more pulses of light 215. In addition, although off-platter detection assembly 200 does not require any bumps or physical barriers at distal edge 130 of weigh platter 105, if desired, a barrier can be positioned at distal edge 130, opposite light emission assembly 205, and can be made of a material and/or color that is absorptive to the wavelength of the pulses of light 215 to prevent reflection of the pulses of light 215 from objects or users that are beyond distal edge 130.

Light detection assembly 250 can also be located within housing 15 and has a field-of-view 255, with a central field-of-view axis 260 that is substantially adjacent to and parallel relative to first lateral edge 120, that extends from proximal edge 115 to at least distal edge 130 and along first lateral edge 120. Light detection assembly 250 has a light sensor 265 that is configured to detect at least a portion of the pulses of light 215 that are reflected from an object 60 that extends across the path of the pulses of light 215, and therefore off weigh platter 105, towards proximal edge 115 and within field-of-view 255. To restrict field-of-view 255, light sensor 265 can be set deep within housing 15 or the path of field-of-view 255 can be folded with reflectors or prisms to locate light sensor 265 wherever needed inside housing 15. The deep inset of light sensor 265 helps light sensor 265 remain immune to other outside light sources. Light sensor 265 can have a second field-of-view 270 that is larger than field-of-view 255 of light detection assembly 250 and an aperture 280, which could be formed in a wall or protrusion of housing 15 or could be formed through another wall or structure that is part of weigh platter assembly 100, can be positioned in front of light sensor 265 to constrain field-of-view 270 of light sensor 265, where a center of aperture 280 is coaxial with a central field-of-view axis 275 of field-of-view 270 of light sensor 265. In addition, a lens 285 can also be positioned in front of aperture 280 and configured to focus the reflected portion of the pulses of light 215 onto light sensor 265. For example, aperture 280 can be 1 millimeter or smaller and be positioned 3 inches back from lens 285, which will provide a magnification of approximately 400% at distal edge 130 of weigh platter 105.

In addition to controlling the illumination and de-illumination of light sources 405, controller 290 is also configured to measure a time-of-flight of a pulse of light reflected from an object 60 (FIG. 7). The time-of-flight is the time elapsed from when the pulse of light is emitted by light emission assembly 205 to when at least a portion of the pulse of light is reflected back to light detection assembly 250 and detected by light sensor 265. Controller 290 can also be configured to determine if object 60 extends across first lateral edge 120 and off of weigh platter 105 by determining if the time-of-flight of the reflected portion of the pulse of light is equal to or greater than a predetermined time-of-flight, which is the predetermined time elapsed from when a light pulse is emitted by light emission assembly 205 to when at least a portion of the pulse of light is reflected back to light detection assembly 250 from an object that located at distal edge 130 of weigh platter 105 and detected by light sensor 265. If a measured time-of-flight is equal to or greater than the predetermined time-of-flight, or if a pulse of light is not reflected back to light detection assembly 250, this indicates that there is no object extending across first lateral edge 120 between proximal edge 115 and distal edge 130 and controller 290 can be configured to allow the measured weight of the object 60 to be recorded. If the measured time-of-flight is less than the predetermined time-of-flight this indicates that object 60 is extending across first lateral edge 120 between proximal edge 115 and distal edge 130 and, in addition to illuminating and de-illuminating light sources 405 as described above, controller 290 can also be configured to prevent the measured weigh of object 60 from being recorded. Controller 290 can also be configured to determine the location of object 60 along first lateral edge 120 based on the time-of-flight. The shorter the time-of-flight, the closer object 60 is to light sensor 265 and, therefore, to proximal edge 115. The longer the time-of-flight, the further object 60 is from light sensor 265 and, therefore, from proximal edge 115.

In operation, light emission assembly 205 of off-platter detection assembly 200 emits pulses of light 215 from light source 210 along first lateral edge 120 of weigh platter 105. Light detection assembly 250 has field-of-view 255 along first lateral edge 120. When an object 60 extends across the path of the pulses of light 215, and therefore is off the weigh platter 105, a portion of the pulses of light 215 are reflected from object 60 and towards light sensor 265 and light sensor 265 detects the portion of the pulses of light 215 reflected from object 60. Controller 290 receives a signal from light sensor 265 indicating that reflected light from object 60 has been detected and a time the reflected light was detected. Depending on the time-of-flight of the reflected light, controller 290 then determines if object 60 extends across first lateral edge 120 and off weigh platter 105 and, if so, the location that object 60 extends across first lateral edge 120, as discussed above.

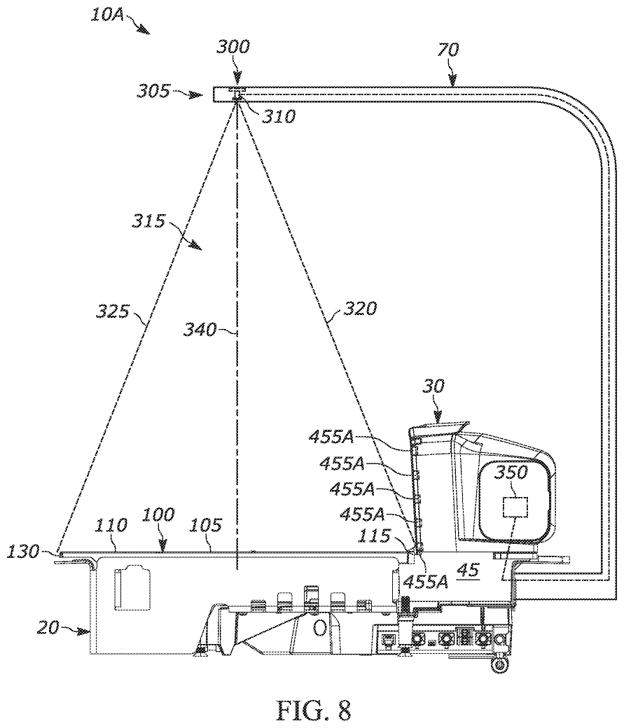

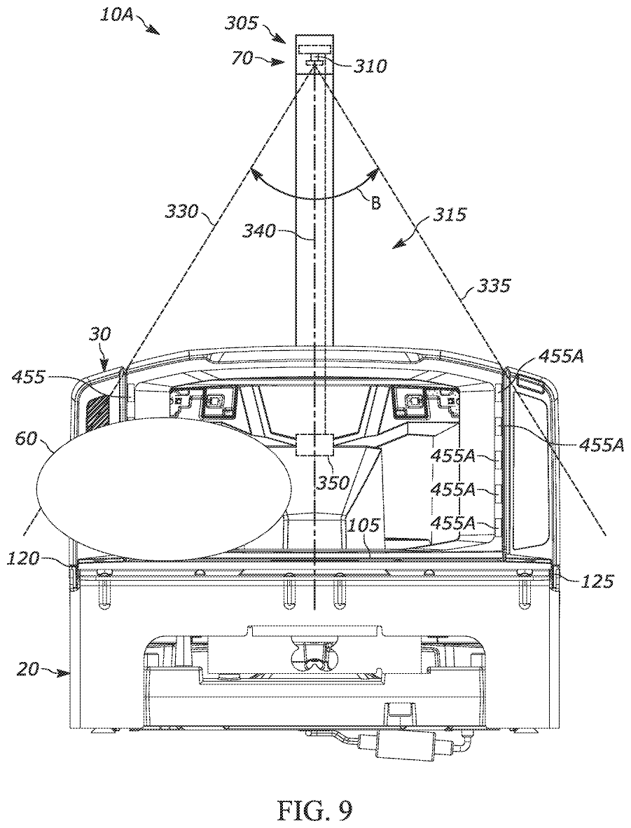

FIGS. 8-9 illustrate a checkout workstation 10A with an off-platter indication system 450 and one particular example of an off-platter detection assembly 300, which in the example shown is a camera based system. In this example, off-platter detection assembly 300 generally includes an overhead imaging assembly 305 and controller 350 operatively coupled to overhead imaging assembly 305, which is positioned substantially above weigh platter 105 and looks down on weigh platter 105. Positioning overhead imaging assembly 305 above and looking down on weigh platter 105 locates overhead imaging assembly 305 far enough above tall objects being weighted so as to reduce the chance that a tall object would falsely trigger off-platter detection assembly 300. Overhead imaging assembly 305 can be an imaging assembly that is dedicated to off-platter detection assembly 300 or an imaging assembly that is already part of the checkout workstation 10 and used for object recognition and is positioned above and looking down on weigh platter 105. Overhead imaging assembly 305 includes an imager 310, preferably a 2 mega pixel camera, that has a field-of-view 315 that extends downward towards upper surface 110 of weigh platter 105 and is configured to capture an image of upper surface 110 of weigh platter 105 with object 60 located on weigh platter 105, including first lateral edge 120 and second lateral edge 125, within field-of-view 315. Field-of-view 315 has a proximal boundary 320, a distal boundary 325, opposite proximal boundary 320, a first lateral boundary 330, and a second lateral boundary 335, opposite first lateral boundary 330. To provide the maximum amount of lateral coverage of upper surface 110, field-of-view 315 preferably has a transverse field-of-view angle B between first lateral boundary 330 and second lateral boundary 335 that is within the range of 100 degrees and 135 degrees.

In the example shown, the checkout workstation 10A includes a gooseneck post 70 that extends from a back of housing 15 and extends over weigh platter 105 and overhead imaging assembly 305 is positioned within gooseneck post 70 such that a central axis 340 of field-of-view 315 extends generally perpendicular to upper surface 110 of weigh platter 105. Alternatively, rather than being positioned within gooseneck post 70, overhead imaging assembly 305 could be mounted or positioned in any position above and looking down on weigh platter 105, such as in a ceiling or as part of an overhead object recognition system or security system overlooking weigh platter 105. To provide the maximum amount of longitudinal coverage of upper surface 110, overhead imaging assembly 305 can be positioned such that proximal boundary 320 of field-of-view 315 intersects upper surface 110 of weigh platter 105 at or substantially adjacent proximal edge 115 (e.g., within the range of 0-30 mm of proximal edge 115) and distal boundary 325 extends to or beyond distal edge 130.

Controller 350 can be calibrated initially (at the factory or during installation or final testing) by being configured to identify and locate first lateral edge 120 and second lateral edge 125 based on a training image of upper surface 110 of weigh platter 105 within field-of-view 315. The training image is an image of upper surface 110 of weigh platter 105 without an object placed on weigh platter 105 and first lateral edge 120 and second lateral edge 125 within field-of-view 315. For example, the location of the first and second lateral edges 120, 125 can be identified by a user observing the training image by drawing or indicating lies on the training image using a configuration tool or the first and second lateral edges 120, 125 could be detected automatically by controller 350.

In addition to controlling the illumination and de-illumination of light sources 455, controller 350 is also configured to receive an image from imager 310 and determine if an object 60 (FIG. 9) positioned on weigh platter 105 extends over first or second lateral edges 120, 125 and, if so, determine the location of object 60 along first lateral or second lateral edge 120, 125 based on the image. Controller 350 can be configured to determine if and where object 60 extends over first or second lateral edges 120, 125 by determining if part of the first or second lateral edges 120, 125 or the gap between weigh platter 105 and lower housing 20 or workstation 50, determined during calibration based on the training image, is blocked or not visible. Controller 350 can also use a convolutional neural network (CNN) to determine whether object 60 extends over first or second lateral edges 120, 125, for example, by identifying object 60 and its orientation and comparing it against a database of dimensional data to determine whether object 60 crosses first or second lateral edges 120, 125. If controller 350 determines that object 60 does not extend over either first or second lateral edges 120, 125, controller 350 can be configured to allow the measured weight of object 60 to be recorded. If controller 350 determines that object 60 does extend over first lateral edge 120 and/or second lateral edge 125, in addition to the illumination and de-illumination of light sources 455 as described above, controller 350 can be configured to prevent the measured weight of object 60 from being recorded.

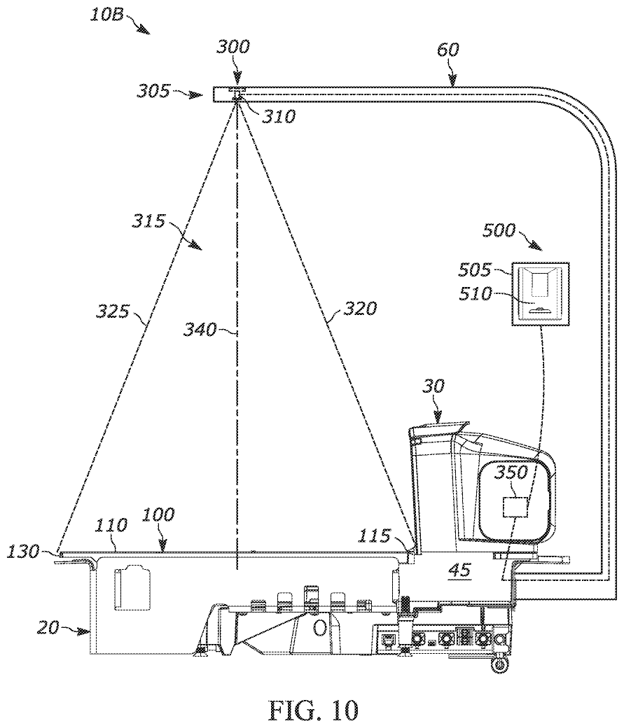

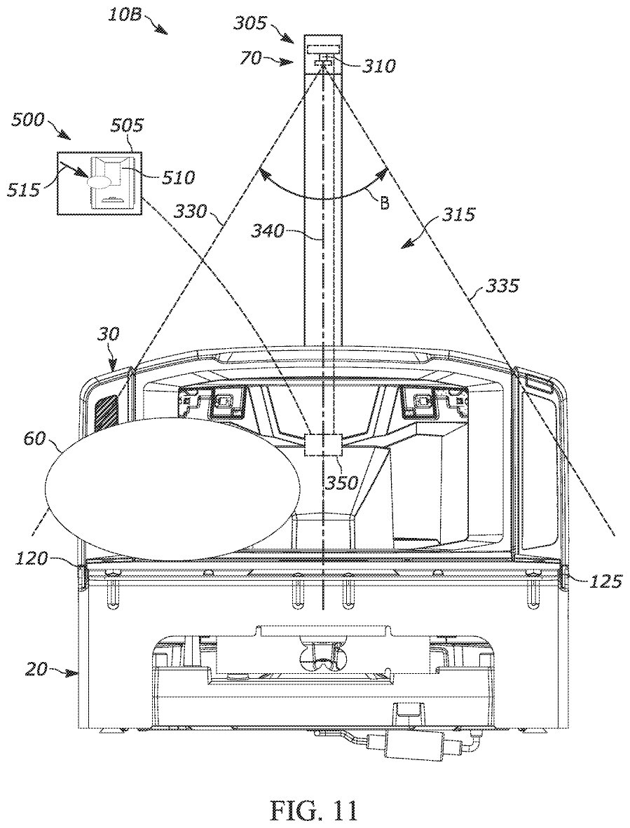

Referring to FIGS. 10-11, a third example checkout workstation 10B is illustrated that is the same as checkout workstation 10A with off-platter detection assembly 300 described above and shown in FIGS. 8-9, but includes a third example off-platter indication system 500, rather than off-platter indication system 450. In checkout workstation 10B, off-platter indication system 500 is in communication with controller 350 and has a visual display 505, which could be a display of checkout workstation 10B, a display or monitor that is separate from and in communication with checkout workstation 10B, or a display of a point-of-sale system operatively coupled to checkout workstation 10B. In this example, if controller 350 determines that object 60 does extend over first lateral edge 120 and/or second lateral edge 125, rather than controlling the illumination and de-illumination of light sources 455, controller 350 can be configured to display a platter representation 510 on visual display 505 with an indication 515 of the location where object 60 extends over first and/or second lateral edges 120, 125. Platter representation 510 can be a live video feed that controller 350 receives from overhead imaging assembly 305, a photographic representation of weigh platter 105, or a drawing or rendering of weigh platter 105. As shown, indication 515 is an arrow that points to the location that object 60 extends across first and/or second lateral edges 120, 125, but indication 515 could be any indicator that would communicate to the user the location, such as highlighting a portion of weigh platter 105 where the off-platter event is occurring. In addition to providing an alert to a user on visual display 505, controller 350 can also be configured to allow the measured weight of object 60 to be recorded if controller 350 determines that object 60 does not extend over either first or second lateral edges 120, 125 and controller 350 can prevent the measured weight of object 60 from being recorded if controller 350 determines that object 60 does extend over either first or second lateral edges 120, 125.

Furthermore, since field-of-view 315 of overhead imaging assembly 305 encompasses the entire weigh platter 105, including distal edge 130, in addition to determining if object 60 extends over first or second lateral edges 120, 125, controller 350 can be configured to determine if object 60 extends over distal edge 130 based on the image and, if so, determine a location where object 60 extends over distal edge 130. If controller 350 determines that object 60 extends over distal edge 130, off-platter indication system 500 can display platter representation 510 on visual display 505 with indication 515 of the location where object 60 extends over distal edge 130 displayed in platter representation 510. In addition to providing an alert to a user on visual display 505, controller 350 can also be configured to allow the measured weight of object 60 to be recorded if controller 350 determines that object 60 does not extend over distal edge 130 and prevent the measured weight of object 60 from being recorded if controller 350 determines that object 60 does extend over distal edge 130.

FIG. 12 illustrates a block diagram of an example process 1200 as may be implemented by the system of FIG. 1 for preventing accidental triggers for off-platter detection systems based on input from a weighing scale. One or more steps of the method 1200 may be implemented as a set of instructions stored on a computer-readable memory (e.g., memory 1116 and/or memory 1122) and executable on one or more processors (e.g., processors 1114 and/or processors 1120).

At block 1202, the weight of an object placed on a weighing platter, as measured by a weighing scale (e.g., weighing scale 1102) associated with a POS system, may be monitored.

At block 1204, the weighing platter may be monitored for instances of off-platter conditions, e.g., by the off-platter detection system 1104.

At block 1206, an audible and/or visible alert may be generated (e.g., by any of the off-platter detection system 1104, product identification system 1106, or POS system 1108) responsive to at least (i) detecting an off-platter condition, and (ii) the weighing scale measuring a positive, stable weight greater than a threshold weight, for a time period greater than a threshold time period. That is, the alert may only be generated when an off-platter condition is detected, and the weighing scale measures a positive stable weight greater than the threshold weight for a time period greater than the threshold time period, and not when only one of these conditions are met.

FIG. 13 illustrates a block diagram of an example process 1300 as may be implemented by the system of FIG. 1 for preventing accidental triggers for off-platter detection systems based on input from an imaging assembly. One or more steps of the method 1300 may be implemented as a set of instructions stored on a computer-readable memory (e.g., memory 1116 and/or memory 1122) and executable on one or more processors (e.g., processors 1114 and/or processors 1120).

At block 1302, the weight of an object, placed on a weighing platter, as measured by a weighing scale (e.g., weighing scale 1102) associated with a POS system may be monitored.

At block 1304, the weighing platter may be monitored for instances of off-platter conditions, e.g., by the off-platter detection system 1104.

At block 1306, image data associated with the object placed on the weighing platter may be captured, e.g., by a barcode reader such as the barcode reader 1111, and/or by an imaging assembly such as the imaging assembly 1113. For instance, the image data may include images of the object itself and/or images of a barcode, QR code, or other symbols or markings associated with the object.

At block 1308, the image data may be analyzed to identify at least one parameter related to the object placed on the weighing platter. In some examples, analyzing the image data associated with the object to identify at least one parameter related to the object may include analyzing the image data associated with the object to identify a payload of a barcode associated with the object, which may include an indication of an identification of the object, a price of associated with the object, and/or a category associated with the object (e.g., produce or not produce, priced by weight or not priced by weight, etc.), etc. Additionally, in some examples, analyzing the image data associated with the object to identify at least one parameter related to the object may include analyzing the image data associated with the object using object recognition techniques to identify the object. Furthermore, in some examples, analyzing the image data associated with the object to identify at least one parameter related to the object may include analyzing the image data to identify symbols or markings associated with the object indicative of an identification of the object, a price of associated with the object, and/or a category associated with the object (e.g., produce or not produce, priced by weight or not priced by weight, etc.), etc. In some examples, the image data may be analyzed to identify an indication of the identification of the object, which in turn may be used to determine one or more further parameters associated with the object, such as a price of associated with the object, and/or a category associated with the object (e.g., produce or not produce, priced by weight or not priced by weight, etc.) e.g., by accessing a database storing various parameters associated with object identifications.

At block 1310, an audible and/or visible alert may be generated (e.g., by any of the off-platter detection system 1104, product identification system 1106, or POS system 1108) responsive to at least (i) detecting an off-platter condition, and (ii) a secondary condition based on identifying the at least one parameter related to the object placed on the weighing platter. For instance, in some examples, the secondary condition may be based on identifying that the object is a produce object, e.g., the alert is only generated when an off-platter condition is detected, and the object is a produce object, but not when an off-platter condition is detected and the object is not a produce object. Additionally, in some examples, the secondary condition may be based on identifying that the object is associated with a price value above a threshold price value, e.g., the alert is only generated when an off-platter condition is detected and the price associated with the object is above a threshold price value, but not when an off-platter condition is detected and the price associated with the object is below the threshold price value. This threshold price value may be set by a user. Furthermore, in some examples, the secondary condition may be based on identifying that the object is priced based on weight, e.g., the alert is only generated when an off-platter condition is detected for an object that is priced based on weight, but not when an off-platter condition is detected for an object that is not priced based on weight.

Moreover, in some examples, generating the alert may be further responsive to a measurement, by the weighing scale, of a stable weight for a time period greater than a threshold time period. That is, the alert may only be generated when an off-platter condition is detected, the secondary condition is detected, and the weighing scale has measured a stable weight for greater than the threshold time period. Additionally, in some examples, generating the alert may be further responsive to a measurement, by the weighing scale, of a stable weight greater than a threshold weight. That is, the alert may only be generated when an off-platter condition is detected, the secondary condition is detected, and the weighing scale has measured a weight greater than the threshold weight. Furthermore, in some examples, generating the alert may be further responsive to a identifying an indication that the object has been placed on the weighing platter for a time period greater than a threshold time period. That is, the alert may only be generated when an off-platter condition is detected, the secondary condition is detected, and the object has been placed on the first surface for the time period greater than the threshold time period. Identifying the indication that the object has been placed on the weighing platter for greater than the threshold time period may include analyzing the image data captured by the imaging assembly to determine that pixels of the image data having a brightness greater than a threshold brightness threshold have not moved for the time period.

FIG. 14 illustrates a block diagram of an example process 1400 as may be implemented by the system of FIG. 1 for preventing accidental triggers for off-platter detection systems based on input from a user. One or more steps of the method 1400 may be implemented as a set of instructions stored on a computer-readable memory (e.g., memory 1116 and/or memory 1122) and executable on one or more processors (e.g., processors 1114 and/or processors 1120).

At block 1402, the weight of an object, placed on a weighing platter, as measured by a weighing scale (e.g., weighing scale 1102) associated with a POS system may be monitored.

At block 1404, the weighing platter may be monitored for instances of off-platter conditions, e.g., by the off-platter detection system 1104.

At block 1406, user input associated with the object placed on the weighing platter may be captured, e.g., by the user interface 1112. For instance, the user input may include an indication of an identification of the object (e.g., the user may indicate that the object is an apple), or an indication of a number, code, or one or more symbols or markings associated with the object. Additionally, the user input may include an indication of a category associated with the object (e.g., produce or not produce, priced by weight or not priced by weight, etc.).

At block 1408, the user input may be analyzed to identify at least one parameter related to the object placed on the weighing platter. In some examples, the user input may be analyzed to identify an indication of the identification of the object, which in turn may be used to determine one or more further parameters associated with the object, such as a price of associated with the object, and/or a category associated with the object (e.g., produce or not produce, priced by weight or not priced by weight, etc.) e.g., by accessing a database storing various parameters associated with object identifications.

At block 1410, an audible and/or visible alert may be generated (e.g., by any of the off-platter detection system 1104, product identification system 1106, or POS system 1108) responsive to at least (i) detecting an off-platter condition, and (ii) a secondary condition based on identifying the at least one parameter related to the object placed on the weighing platter. For instance, in some examples, the secondary condition may be based on identifying that the object is a produce object, e.g., the alert is only generated when an off-platter condition is detected, and the object is a produce object, but not when an off-platter condition is detected and the object is not a produce object. Additionally, in some examples, the secondary condition may be based on identifying that the object is associated with a price value above a threshold price value, e.g., the alert is only generated when an off-platter condition is detected and the price associated with the object is above a threshold price value, but not when an off-platter condition is detected and the price associated with the object is below the threshold price value. This threshold price value may be set by a user. Furthermore, in some examples, the secondary condition may be based on identifying that the object is priced based on weight, e.g., the alert is only generated when an off-platter condition is detected for an object that is priced based on weight, but not when an off-platter condition is detected for an object that is not priced based on weight.

Moreover, in some examples, generating the alert may be further responsive to a measurement, by the weighing scale, of a stable weight for a time period greater than a threshold time period. That is, the alert may only be generated when an off-platter condition is detected, the secondary condition is detected, and the weighing scale has measured a stable weight for greater than the threshold time period. Additionally, in some examples, generating the alert may be further responsive to a measurement, by the weighing scale, of a stable weight greater than a threshold weight. That is, the alert may only be generated when an off-platter condition is detected, the secondary condition is detected, and the weighing scale has measured a weight greater than the threshold weight. Furthermore, in some examples, generating the alert may be further responsive to a identifying an indication that the object has been placed on the weighing platter for a time period greater than a threshold time period. That is, the alert may only be generated when an off-platter condition is detected, the secondary condition is detected, and the object has been placed on the first surface for the time period greater than the threshold time period. Identifying the indication that the object has been placed on the weighing platter for greater than the threshold time period may include, for instance, capturing image data associated with the object placed on the weighing platter (e.g., by the imaging assembly 1113), and analyzing the image data captured by the imaging assembly to determine that pixels of the image data having a brightness greater than a threshold brightness threshold have not moved for the time period.

FIG. 15 illustrates a block diagram of an example process 1500 as may be implemented by the system of FIG. 1 for preventing accidental triggers for off-platter detection systems based on input from a product identification system. One or more steps of the method 1500 may be implemented as a set of instructions stored on a computer-readable memory (e.g., memory 1116 and/or memory 1122) and executable on one or more processors (e.g., processors 1114 and/or processors 1120).

At block 1502, the weight of an object, placed on a weighing platter, as measured by a weighing scale (e.g., weighing scale 1102) associated with a POS system may be monitored.

At block 1504, the weighing platter may be monitored for instances of off-platter conditions, e.g., by the off-platter detection system 1104.

At block 1506, data associated with the object placed on the weighing platter may be captured, e.g., by the product identification system 1106. For instance, the data associated with the object may include barcode data (e.g., captured by a barcode reader 1111), user input data (e.g., captured by a user interface 1112), image data (e.g., captured by an imaging assembly 1113), and/or other data, such as, for instance, RFID tag data associated with the object captured by an RFID reader (not shown), or any combination of these various types of data that may be associated with the object.

At block 1508, the data associated with the object placed on the weighing platter may be analyzed to identify at least one parameter related to the object placed on the weighing platter. In some examples, analyzing the data associated with the object to identify at least one parameter related to the object may include analyzing the image data associated with the object to identify a payload of a barcode or RFID tag associated with the object, which may include an indication of an identification of the object, a price of associated with the object, and/or a category associated with the object (e.g., produce or not produce, priced by weight or not priced by weight, etc.), etc. Additionally, in some examples, analyzing the data associated with the object to identify at least one parameter related to the object may include analyzing any image data associated with the object using object recognition techniques to identify the object. Furthermore, in some examples, analyzing the data associated with the object to identify at least one parameter related to the object may include analyzing the data associated with the object (e.g., image data, user input data, etc.) to identify symbols or markings associated with the object, which may be indicative of an identification of the object, a price of associated with the object, and/or a category associated with the object (e.g., produce or not produce, priced by weight or not priced by weight, etc.), etc. In some examples, the data associated with the object may be analyzed to identify an indication of the identification of the object, which in turn may be used to determine one or more further parameters associated with the object, such as a price of associated with the object, and/or a category associated with the object (e.g., produce or not produce, priced by weight or not priced by weight, etc.) e.g., by accessing a database storing various parameters associated with object identifications.

At block 1510, an audible and/or visible alert may be generated (e.g., by any of the off-platter detection system 1104, product identification system 1106, or POS system 1108) responsive to at least (i) detecting an off-platter condition, and (ii) a secondary condition based on identifying the at least one parameter related to the object placed on the weighing platter. For instance, in some examples, the secondary condition may be based on identifying that the object is a produce object, e.g., the alert is only generated when an off-platter condition is detected, and the object is a produce object, but not when an off-platter condition is detected and the object is not a produce object. Additionally, in some examples, the secondary condition may be based on identifying that the object is associated with a price value above a threshold price value, e.g., the alert is only generated when an off-platter condition is detected and the price associated with the object is above a threshold price value, but not when an off-platter condition is detected and the price associated with the object is below the threshold price value. This threshold price value may be set by a user. Furthermore, in some examples, the secondary condition may be based on identifying that the object is priced based on weight, e.g., the alert is only generated when an off-platter condition is detected for an object that is priced based on weight, but not when an off-platter condition is detected for an object that is not priced based on weight.

Moreover, in some examples, generating the alert may be further responsive to a measurement, by the weighing scale, of a stable weight for a time period greater than a threshold time period. That is, the alert may only be generated when an off-platter condition is detected, the secondary condition is detected, and the weighing scale has measured a stable weight for greater than the threshold time period. Additionally, in some examples, generating the alert may be further responsive to a measurement, by the weighing scale, of a stable weight greater than a threshold weight. That is, the alert may only be generated when an off-platter condition is detected, the secondary condition is detected, and the weighing scale has measured a weight greater than the threshold weight. Furthermore, in some examples, generating the alert may be further responsive to a identifying an indication that the object has been placed on the weighing platter for a time period greater than a threshold time period. That is, the alert may only be generated when an off-platter condition is detected, the secondary condition is detected, and the object has been placed on the first surface for the time period greater than the threshold time period. Identifying the indication that the object has been placed on the weighing platter for greater than the threshold time period may include, for instance, capturing image data associated with the object placed on the weighing platter (e.g., by the imaging assembly 1113), and analyzing the image data captured by the imaging assembly to determine that pixels of the image data having a brightness greater than a threshold brightness threshold have not moved for the time period.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system for use with a point of sale (POS) terminal that is operable to execute a transaction associated with a purchase of an object, the system comprising:
a weigh platter having a first surface extending in a first transverse plane;
a scale configured to measure a weight of the object when placed on the first surface;
an off-platter detection assembly configured to detect an off-platter condition based on at least one of (i) a portion of the object resting on a second surface off the weigh platter and (ii) at least some portion of the object extending beyond a perimeter of the weigh platter;
a processor in communication with the scale and the off-platter detection assembly; and
a non-transitory machine-readable storage medium storing instructions that, when executed by the processor, cause the system to generate an alert responsive to at least: (i) the off-platter detection assembly detecting the off-platter condition and (ii) a measurement by the scale of a stable weight greater than a threshold weight, for a time period greater than a threshold time period.

2. A system for use with a point of sale (POS) terminal that is operable to execute a transaction associated with a purchase of an object, the system comprising:
a weigh platter having a first surface extending in a first transverse plane;
a scale configured to measure a weight of the object when placed on the first surface;
an off-platter detection assembly configured to detect an off-platter condition based on at least one of (i) a portion of the object resting on a second surface off the weigh platter or (ii) at least some portion of the object extending beyond a perimeter of the weigh platter;
an imaging assembly configured to capture image data associated with the object when placed on the first surface;
a processor in communication with the scale and the off-platter detection assembly; and
a non-transitory machine-readable storage medium storing instructions that, when executed by the processor, cause the system to:
analyze the image data associated with the object captured by the imaging assembly to identify at least one parameter related to the object; and
generate an alert responsive to at least: (i) the off-platter detection assembly detecting the off-platter condition and (ii) a secondary condition, based on identifying the at least one parameter related to the object, being met.

3. The system of claim 2, wherein analyzing the image data associated with the object to identify at least one parameter related to the object includes analyzing the image data associated with the object to identify a payload of a barcode associated with the object.

4. The system of claim 2, wherein analyzing the image data associated with the object to identify at least one parameter related to the object includes analyzing the image data associated with the object using object recognition techniques to identify the object.

5. The system of claim 2, wherein the secondary condition is based on identifying that the object is a produce object.

6. The system of claim 2, wherein the secondary condition is based on identifying that the object is associated with a price value above a threshold price value.

7. The system of claim 2, wherein the secondary condition is based on identifying that the object is priced based on weight.

8. The system of claim 2, wherein the alert is further responsive to: a measurement by the scale of a stable weight for a time period greater than a threshold time period.

9. The system of claim 2, wherein the alert is further responsive to: a measurement by the scale of a weight greater than a threshold weight.

10. The system of claim 2, wherein the alert is further responsive to: identifying an indication that the object has been placed on the first surface for a time period greater than a threshold time period.

11. The system of claim 10, wherein identifying the indication that the object has been placed on the first surface for the time period greater than the threshold time period includes analyzing the image data captured by the imaging assembly to determine that pixels of the image data having a brightness greater than a threshold brightness threshold have not moved for the time period.

12. A system for use with a point of sale (POS) terminal that is operable to execute a transaction associated with a purchase of an object, the system comprising:
a weigh platter having a first surface extending in a first transverse plane;
a scale configured to measure a weight of the object when placed on the first surface;
an off-platter detection assembly configured to detect an off-platter condition based on at least one of (i) a portion of the object resting on a second surface off the weigh platter and (ii) at least some portion of the object extending beyond a perimeter of the weigh platter;
a user interface configured to capture user input associated with the object;
a processor in communication with the scale and the off-platter detection assembly; and
a non-transitory machine-readable storage medium storing instructions that, when executed by the processor, cause the system to
analyze the user input associated with the object captured by to identify at least one parameter related to the object; and
generate an alert responsive to at least: (i) the off-platter detection assembly detecting the off-platter condition and (ii) a secondary condition, based on identifying the at least one parameter related to the object, being met.

13. The system of claim 12, wherein the secondary condition is based on identifying that the object is a produce object.

14. The system of claim 12, wherein the secondary condition is based on identifying that the object is associated with a price value above a threshold price value.

15. The system of claim 12, wherein the secondary condition is based on identifying that the object is priced based on weight.

16. The system of claim 12, wherein the alert is further responsive to: a measurement by the scale of a stable weight for a time period greater than a threshold time period.

17. The system of claim 12, wherein the alert is further responsive to: a measurement by the scale of a weight greater than a threshold weight.

18. A system for use with a point of sale (POS) terminal that is operable to execute a transaction associated with a purchase of an object, the system comprising:
a weigh platter having a first surface extending in a first transverse plane;
a scale configured to measure a weight of the object when placed on the first surface;
an off-platter detection assembly configured to detect an off-platter condition based on at least one of (i) a portion of the object resting on a second surface off the weigh platter or (ii) at least some portion of the object extending beyond a perimeter of the weigh platter;
a product identification module configured to capture data associated with the object;
a processor in communication with the scale and the off-platter detection assembly; and
a non-transitory machine-readable storage medium storing instructions that, when executed by the processor, cause the system to:
analyze the data captured by the product identification module to identify at least one parameter related to the object; and
generate an alert responsive to at least: (i) the off-platter detection assembly detecting the off-platter condition and (ii) the at least one parameter associated with the object.

19. The system of claim 18, wherein the secondary condition is based on identifying that the object is a produce object.

20. The system of claim 18, wherein the secondary condition is based on identifying that the object is associated with a price value above a threshold price value.

21. The system of claim 18, wherein the secondary condition is based on identifying that the object is priced based on weight.

22. The system of claim 18, wherein the alert is further responsive to: a measurement by the scale of a stable weight for a time period greater than a threshold time period.

23. The system of claim 18, wherein the alert is further responsive to: a measurement by the scale of a weight greater than a threshold weight.
